(19) United States
(12) Patent Application Publication
(10) Pub. No.: US 2010/0300629 A1
(43) Pub. Date: Dec. 2, 2010

(54) WINDOW COVERINGS

(76) Inventor: Sandra Virden, Moore, OK (US)

Correspondence Address: Sandra Virden, 820 SE 12st St., Moore, OK, 73160, US

(21) Appl. No.: 12/767,589

(22) Filed: Apr. 26, 2010

Related U.S. Application Data
(60) Provisional application No. 61/183,194, filed on Jun. 2, 2009.

(51) Int. Cl. E06B 9/06

(52) U.S. Cl. 160/84.04

(57) ABSTRACT

A free standing window covering does not need any holes in the window frame to keep the window covering in place. The window covering may contain a number of folds to provide a covering for bay and bow windows. The window covering may offer privacy and insulation in a lightweight removable window covering.

### CROSS-REFERENCE TO RELATED APPLICATION

This application claims the benefit of U.S. Provisional Patent application No. 61/183,194, filed Jun. 2, 2009, which is herein incorporated by reference.

### BACKGROUND OF THE INVENTION

The present invention relates to window coverings and, more particularly, to free standing, folding insulated window coverings that may offer privacy and heat/cold retention.

Bay windows are a beautiful addition to any home and provide a wonderful view. They also present difficulty in providing privacy because of the angles. With windows where people move in and out of the unit frequently, such as windows in living quarters, may have a problem with holes in woodwork, eventually ruining the window casement. In addition to these issues, conventional drapes, when they can be used, may not provide adequate insulation properties.

As can be seen, there is a need for a window covering for a window that may be free standing and that may provide insulation.

### SUMMARY OF THE INVENTION

In one aspect of the present invention, a window covering comprises an insulating panel; a plurality of vertical hinges in the insulating panel; wherein the hinges are positioned to allow the insulating panel to conform to the shape of a window, and wherein the insulating panel is adapted to be free standing.

In another aspect of the present invention, an insulating free standing window covering for a bow or bay window comprises an insulating panel; a plurality of scores cut into the insulating panel, the scores allowing the insulating panel to bend to a shape to conform to the shape of a window; an edging around an outside edge of the window covering; and a decorative covering on at least one side of the insulating panel.

These and other features, aspects and advantages of the present invention will become better understood with reference to the following drawings, description and claims.

### BRIEF DESCRIPTION OF THE DRAWINGS

FIG. 1 is a perspective view of the window covering according to an embodiment of the present invention, in use on a bay window;

FIG. 2 is a perspective view illustrating measurements of a bay window;

FIG. 3A is a perspective view illustrating a first step in making the window covering of FIG. 1;

FIG. 3B is a perspective view illustrating a second step in making the window covering of FIG. 1;

FIG. 3C is a perspective view illustrating a third step in making the window covering of FIG. 1;

FIG. 3D is a perspective view illustrating a fourth step in making the window covering of FIG. 1;

FIG. 3E is a perspective view illustrating a fifth step in making the window covering of FIG. 1;

FIG. 3F is a perspective view illustrating a sixth step in making the window covering of FIG. 1;

FIG. 4 is a perspective view illustrating an alternate use of the window covering of FIG. 1;

FIG. 5 is a perspective view illustrating the use of the window covering of FIG. 1 as a partial window cover;

FIG. 6 is a perspective view of an alternate embodiment of a window covering according to the present invention;

FIG. 7 is a back side view of an alternate embodiment of a window covering according to the present invention;

FIG. 8 is a perspective view of an alternate embodiment of a window covering according to the present invention, for use in a bow window;

FIG. 9A is a perspective view of an alternate embodiment of a window covering according to the present invention in a partially open position; and

FIG. 9B is a perspective view of the window covering of FIG. 9A in a closed position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a free standing window covering that does not need any holes in the window frame to keep the window covering in place. The window covering may contain a number of folds to provide a covering for bay and bow windows. The window covering may offer privacy and insulation in a lightweight removable window covering.

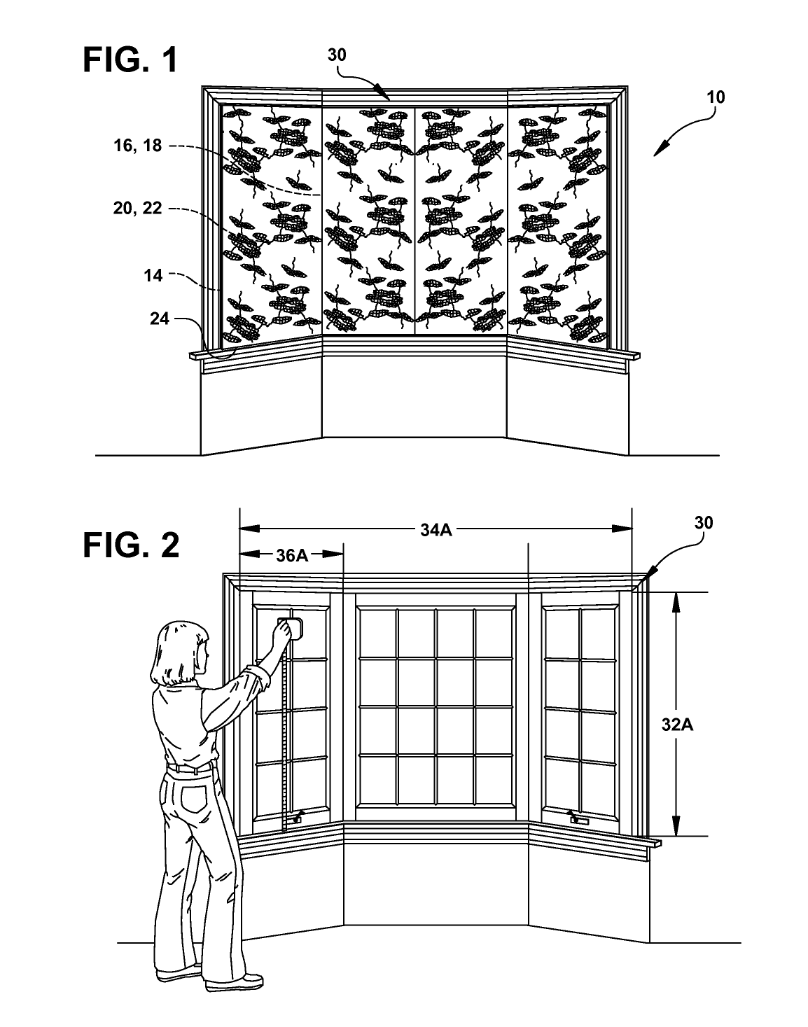

Referring to FIG. 1, a window covering 10 may include a number of sections attached together at vertical hinges 18. The hinges 18 may be located at angles in a bay window 30, for example. The window covering 10 may include an edging 14 at the sides and, optionally, at the top of the window covering 10. The window covering 10 may further include a glideable material, such as plastic balls or slides, at a bottom surface of the window covering 10.

The window covering 10 may be made of, for example, rigid insulation having a thickness from about ¼ to about ¾ inch, typically about ½ inch. The rigid insulation may have a foil backing that may be used as hinging, as discussed below. Alternatively, the window covering 10 may be had of a rigid clay covered with foam. In other embodiments, the window covering 10 may be made of rigid paper, wood, plastic, and the like. The window covering 10 may include a decorative cover 20 attached to one or both sides of the window covering 10.

The hinges 18 of the window covering 10 may be formed by partially cutting through the rigid panel. A sturdy plastic tape 16 may join the panels of the window covering 10 to provide the hinge 18. In an alternate embodiment, as shown in FIG. 7, panels 12 of the window covering 10 may be connected with a plurality of hinges 28.

Referring to FIG. 2, the dimensions of the bay window 30 may be measured. For example, the overall width 34A, height 32A, and individual window widths 36A may be measured. Typically, a half-inch is subtracted from height 32A, and two inches may be added to width 34B and 36B for added stability.

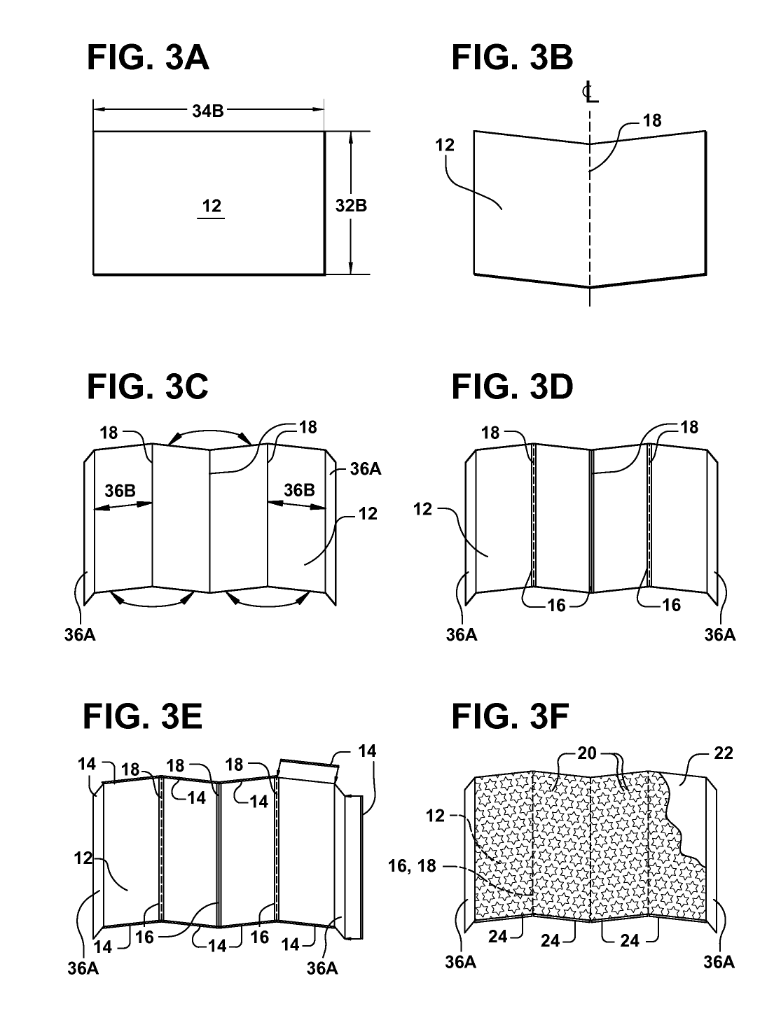

Referring now to FIGS. 3A through 3F, to make the window covering 10, a panel having the overall width 34B and height 32B is formed (FIG. 3A). A first hinge 18 may be made by scoring the panel 12 at each of the individual widths 36B (FIGS. 3B, 3C). Two more scorings may be made on the same side of the cover as hinge 18, two inches into the window covering 10 from the edge, so as to strengthen the edging while moving the cover to and from the window. Tape 16 may be applied to the hinges 18 to secure and strengthen the hinges 18 (FIG. 3D). Edging 14 may then be applied to all the edges of the individual panels 12 (FIG. 3E). The edging 14 on the bottom of the window covering 10 may be a glideable edging 24, thereby aiding a user in the placement and movement of the window covering 10. The edging 14 may be a sealant edging, such as a spray-on sealant edging. Finally, the decorative cover 20 may be applied with, for example, an adhesive 22.

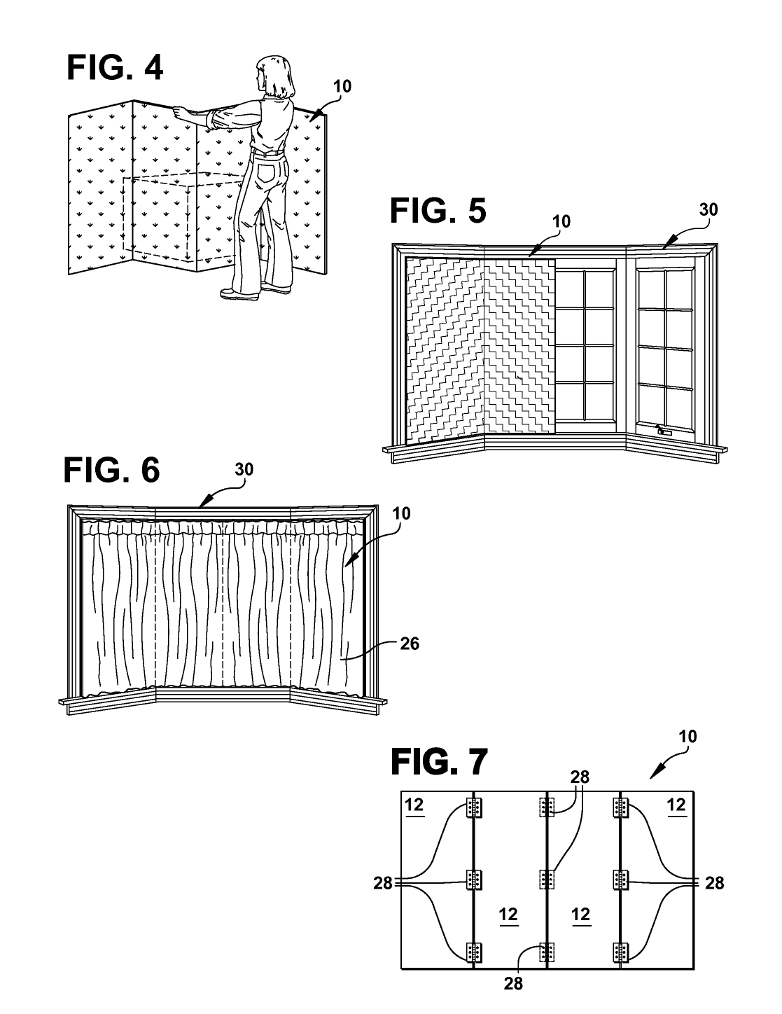

As shown in FIG. 4, the window covering 10 may have other uses, in addition to being used as a window covering. For example, the window covering 10 may be used as a room divider or a privacy screen.

As shown in FIG. 5, the window covering 10 may be folded onto itself to provide a partial window covering. In an alternate embodiment, the window covering may be formed in two or more detachable sections, thereby allowing partial window covering. By forming a window covering in two separate sections, the window covering may be easier to move and place on a window when needed.

As shown in FIG. 6, the window covering 10 may further include a fabric drape 26 attached to a top end of the window covering 10. The drape 26 may be allowed to drape freely, giving the appearance of a conventional window drape, but without the need for a drape hanger and the associate mounting holes needed to attach the drape hanger.

As shown in FIG. 7, and as discussed above, instead of tape 16, the panels 12 may be joined together with a plurality of hinges 28. In this embodiment, the panels may be cut through entirely, as opposed to the previous embodiments, which may permit only scoring the panel 12 to form the hinge.

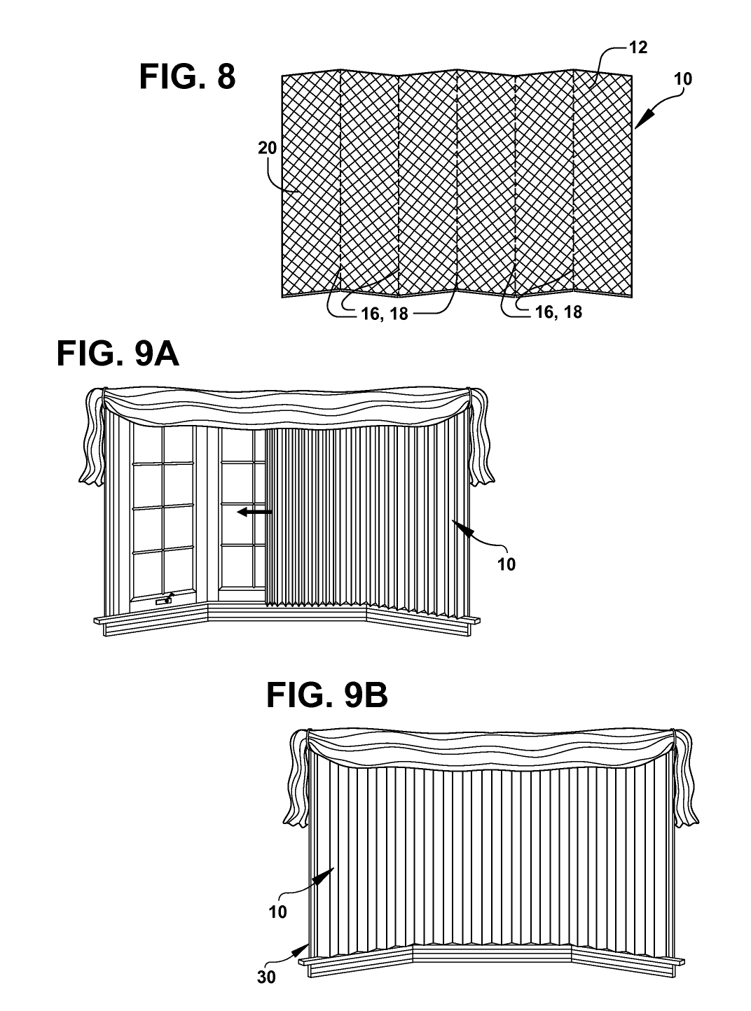

As shown in FIG. 8, the window covering 10 may be formed with a plurality of hinges 18. The increased number of hinges 18 may allow for use in a bow window, for example. The increased number of hinges 18 may also allow for partial window covering at a greater number of degrees as compared to the embodiment of the present invention as shown in FIG. 1.

As shown in FIGS. 9A and 9B, the window covering 10 may include a plurality of closely spaced hinges 18. The closely spaced hinges 18 may be equally spaced apart. For example, the hinges 18 may be formed from about 2 to about 8 inches, typically from about 3 to about 6 inches apart. The hinges 18 may be formed by providing scores in alternating sides of the window covering 10. This embodiment of the present invention may allow a fan-folded window covering that may be fanned open and closed at various degrees of opening.

It should be understood, of course, that the foregoing relates to exemplary embodiments of the invention and that modifications may be made without departing from the spirit and scope of the invention as set forth in the following claims.

We claim:

1. A window covering comprising:
an insulating panel;
a plurality of vertical hinges in the insulating panel;
wherein the hinges are positioned to allow the insulating panel to conform to the shape of a window, and
wherein the insulating panel is adapted to be free standing.

2. The window covering of claim 1, wherein the hinges are formed by scoring one side of the insulating panel and applying a tape to the unscored side of the insulating panel.

3. The window covering of claim 1, wherein the window is a bow window or a bay window.

4. The window covering of claim 1, further comprising an edging around an outside edge of the window covering.

5. The window covering of claim 1, wherein the edging is a spray on sealant.

6. The window covering of claim 1, further comprising a drape attached to a top portion of the window covering.

7. The window covering of claim 1, wherein the hinges are formed in an equally spaced apart close arrangement, thereby permitting the window covering to be fanned open or closed.

8. The window covering of claim 7, wherein the close arrangement includes hinges formed by scoring alternating sides of the insulating panel at a spacing from about 2 to about 8 inches apart.

9. The window covering of claim 1, further comprising a glideable material along a bottom edge of the insulating panel.

10. An insulating free standing window covering for a bow or bay window, the window covering comprising:
an insulating panel;
a plurality of scores cut into the insulating panel, the scores allowing the insulating panel to bend to a shape to conform to the shape of a window;
an edging around an outside edge of the window covering; and
a decorative covering on at least one side of the insulating panel.
